(19) United States
(12) Patent Application Publication
(10) Pub. No.: US 2026/0099355 A1
(43) Pub. Date: Apr. 9, 2026

(54) METHODS AND APPARATUS TO OPTIMIZE ARTIFICIAL INTELLIGENCE INFERENCE WORKLOADS ON AUDIO AND VIDEO DATA STREAMS

(71) Applicant: McAfee, LLC, San Jose, CA (US)

(72) Inventors: Steven Leonard Grobman, Flower Mound, TX (US); German Lancioni, San Jose, CA (US)

(21) Appl. No.: 18/909,646

(22) Filed: Oct. 8, 2024

(51) Int. Cl. G06F 9/48

(52) U.S. Cl. CPC G06F 9/485

(57) ABSTRACT

Systems, apparatus, articles of manufacture, and methods are disclosed to reduce a use of a compute engine executing dense layers in a model. An example apparatus includes obtain a first vector generated by an initial layer of the model, the first vector corresponding to a first data frame, wherein the initial layer of the model utilizes less computation resources than the dense layer is to utilize, measure a similarity between the first vector and a prior vector, wherein the prior vector has been classified by the model and corresponds to a second data frame occurring before the first data frame represented by the first vector, determine that the first vector satisfies a similarity threshold to the prior vector, and instruct the compute engine to enter an idle state, the idle state to suspend execution of the dense layers in the model.

### FIELD OF THE DISCLOSURE

This disclosure relates generally to audio and video data streams and, more particularly, to methods and apparatus to optimize artificial intelligence inference workloads on audio and video data streams.

### BACKGROUND

Artificial Intelligence (AI) models are used to perform different types of inference workloads on audio and/or video. For example, AI can be used to identify a speaker in a given audio track, to assess a content rating of a video, to differentiate music from speech in a given audio track, etc.

### BRIEF DESCRIPTION OF THE DRAWINGS

FIG. 1 is a block diagram of an example classification system in which example optimization circuitry operates to reduce a use of a compute engine executing dense layers of a machine learning model.

FIG. 2 is a block diagram of an example implementation of the optimization circuitry of FIG. 1.

FIG. 3 is a flowchart representative of example machine readable instructions and/or example operations that may be executed, instantiated, and/or performed by example programmable circuitry to implement the optimization circuitry 102 of FIG. 2.

FIG. 4 is a block diagram of an example processing platform including programmable circuitry structured to execute, instantiate, and/or perform the example machine readable instructions and/or perform the example operations of FIG. 3 to implement the optimization circuitry 102 of FIG. 2.

FIG. 5 is a block diagram of an example implementation of the programmable circuitry of FIG. 4.

FIG. 6 is a block diagram of another example implementation of the programmable circuitry of FIG. 4.

FIG. 7 is a block diagram of an example software/firmware/instructions distribution platform (e.g., one or more servers) to distribute software, instructions, and/or firmware (e.g., corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Generally, for inference workloads operating on audio and/or video, to generate accurate results (e.g., accurate identification, accurate content rating, accurate differentiation, etc.), every data frame of the audio and/or video needs to be analyzed by the AI model. If the AI model does not analyze every data frame (e.g., if some data frames are arbitrarily dropped before AI model inference), an efficacy of the system reduces and additionally could render the AI inference useless for sensitive applications. For example, if the data frames are discarded or unused with a certain sampling rate (e.g., data frames skipped every other five seconds for voice identification application), the AI model may generate false positives. In a sensitive application, such as live speaker identification where an AI model identifies a speaker during an audio call, data frame skipping based on a certain sampling rate could result in dropping a data frame associated with a different speaker than previous and subsequent data frames, thus misidentifying who a speaker was at that time. In another example of a sensitive application, where an AI model identifies when audio is generated by a deepfake and, therefore, when audio is being cloned, sparse sampling of the data frames will result in misidentification and/or classification of the audio as deepfake audio.

Depending on the endpoint devices performing the different types of inference workloads, execution of the AI model can become expensive in terms of cost and hardware requirements. For example, processing every frame of media (e.g., audio and/or video) requires, at minimum, high memory bandwidth, throughput, and power. Otherwise, such processing and execution is slow. Therefore, such inference workloads have traditionally been reserved for asynchronous use-cases or cloud-based environment. Inference workloads executed in a cloud-based environment are restricted to a certain capacity and/or scale, and reserving inference workloads for only asynchronous use cases causes slower execution times.

Therefore, examples disclosed herein provide a mechanism that optimizes the AI inference workload by causing a compute engine to switch between idle and awake states while processing the streamed data frames based on analyzing a similarity between successive data frames. As used herein, an “idle state,” a “C-state,” or a “non-use state” of the compute engine is a state where the compute engine suspends execution of a program (e.g., inference) and stops fetching instructions from memory. Processors use idle time to save power. As used herein, an awake state of the compute engine is a state where the compute engine is executing a program and fetching instructions from memory.

Examples disclosed herein intercept an output of lightweight layers of an AI inference workload and measure the similarity between the output and previous outputs. As used herein, a lightweight layer is an initial layer in an inference model that has fewer weights than subsequent layers in the inference model. For example, the first five layers in a fifteen layer model has fewer weights because the first five layers may be embedding layers and/or translations. Because the initial layers are lightweight, a compute engine does not demand high resources and throughput, nor memory bandwidth. Therefore, by intercepting and analyzing the output of the lightweight layers, which are vectors indicative of embeddings and/or translations of one or more data frames, before the output is read by a compute engine that processes the more densely weighted layers, examples disclosed herein can improve inference workloads and improve the performance of a compute engine processing the inference workloads.

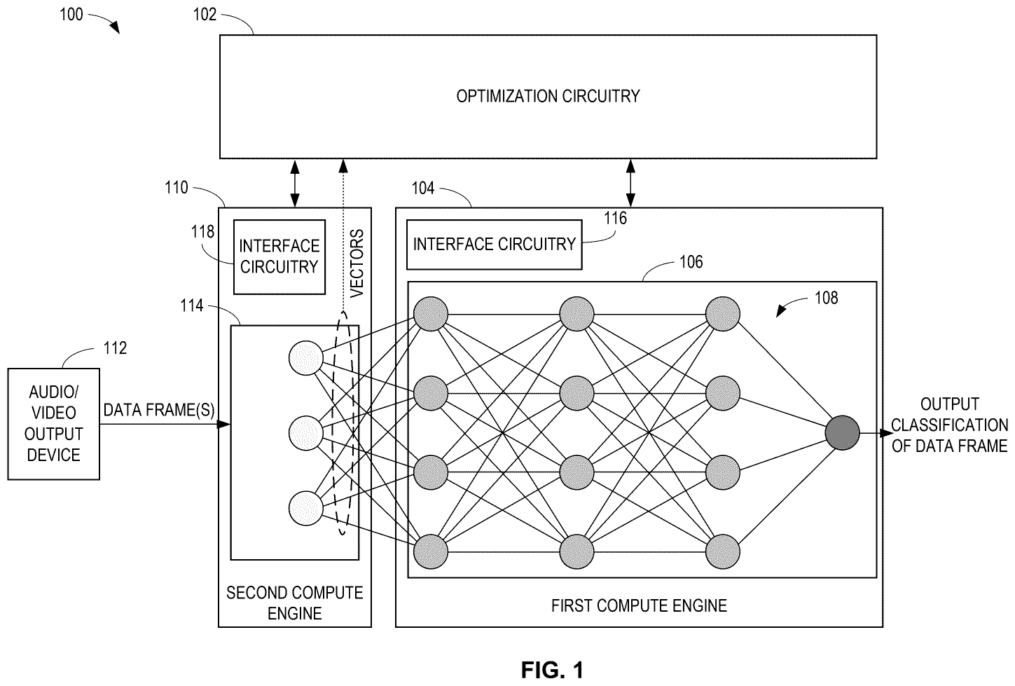

FIG. 1 is a block diagram of an example classification system 100 in which example optimization circuitry 102 operates to reduce a use of an example first compute engine 104 executing dense layers in an example model 108. The classification system 100 includes an example second compute engine 110 and an example audio/video output device 112.

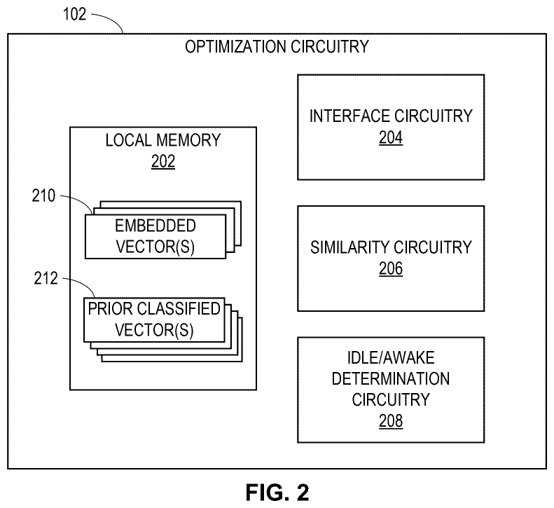

In FIG. 1, the optimization circuitry 102 determines when to instruct the first compute engine 104 to enter an idle state or an awake state. The optimization circuitry 102 obtains vectors output by an example top layer 114 of the model 108 and processed by the second compute engine 110. The optimization circuitry 102 compares a vector to prior classified vectors to determine a similarity between the vector and the prior classified vectors. As used herein, a vector is a numerical representation of an input (e.g., data frame) that captures a meaning and relationship of that input. As used herein, a classified vector is a vector that has been identified by the model 108 as silence/white noise or a particular person, as a clone/fake audio or real audio, as explicit content audio or non/explicit audio, or whatever identification the model was trained to identify. The optimization circuitry 102 is described in further detail below in connection with FIG. 2.

In this example, the model 108 is a speaker recognition model that classifies an audio input as a voice of a particular person or as silence (e.g., broadband noise, a combination of audible sound frequencies in equal measure, etc.). However, the model 108 may be any other type of machine learning model that classifies audio and/or video in some manner. For example, the model 108 could be a convolutional neural network (CNN) that either classifies video input as an action (e.g., an action recognition task) or classifies audio input as being a fake speaker generated using a deepfake or as a verified (e.g., real) speaker. In any scenario, the model 108 processes successive data frames from the audio/video output device 112.

In FIG. 1, the first compute engine 104 is a processor that implements the dense layers 106 of the model 108. The first compute engine 104 includes example first interface circuitry 116 to receive instructions from the optimization circuitry 102. The instructions include whether to enter an idle state or enter an awake state. For example, the optimization circuitry 102 optimizes the resources used by the second compute engine 104 by saving the second compute engine 104 the trouble of processing a vector that doesn't need to be processed based on the vector's similarity to previously processed vectors. The idle state suspends execution of the second compute engine 104 on the dense layers 106 and current vector. The awake state causes the second compute engine 104 to execute the dense layers 106 and classify the current vector.

In this example, the second compute engine 104 is a graphics processing unit (GPU) or a neural processing unit (NPU). The GPU and/or NPU have special processing requirements, such as high throughput, high memory bandwidth, and specialized hardware. For example, the dense layers 106 have SoftMax or sigmoid activation functions which utilize many mathematical calculations and, thus, many computation cycles. SoftMax activation functions generally turn raw outputs of the layers into a vector of probabilities. Sigmoid activation functions are mathematical functions with a characteristic “S”-shaped curve or sigmoid curve and transforms any value in the domain (−∞, ∞) to a number between 0 and 1. These functions, among others, may require specialized hardware depending on the initial inputs to the machine learning model (e.g., model 108). However, not all parts (or layers) of the model 108 require special hardware and resources.

In FIG. 1, the second compute engine 110 is a processor that implements the top layer 114 of the model 108, which does not require special hardware and/or resources. As used herein, the term “top layer” is used interchangeably with the term “initial layer.” The top layer and/or the initial layer is just a first layer in a series of layers in a machine learning model. In this example, the model 108 includes one top layer 114. However, the model 108 may have more than one top layer, depending on the training, the type of model, the inference tasks, etc.

In some examples, execution of the top layer 114 includes vector embedding operations. Any data (e.g., text, audio, or images) that a machine learning model (e.g., model 108) operates on must be expressed numerically. Vector embedding is a way to convert an unstructured data point into an array of numbers that still express the data's original meaning. For example, an audio embedding vector is a numerical representation of audio signals that captures important features of the audio, such as tone, pitch, and rhythm. Vector embedding does not have the special processing requirements that subsequent layers of a machine learning model have (e.g., the dense layers 106 of the model 108). Therefore, the vector embedding layer (e.g., the top layer 114) can be executed by a general purpose processor, such as a CPU, and does not require the same amount of computation resources as the subsequent layers of the model 108.

The second compute engine 110 includes example second interface circuitry 118 to receive requests from the optimization circuitry 102 and send information (e.g., vectors) to the optimization circuitry 102. For example, the second interface circuitry 118 communicates data between the second compute engine 110 and the optimization circuitry 102. In some examples, the second interface circuitry 118 communicates with the audio/video output device 112. For example, the second interface circuitry 118 obtains data frames from the audio/video output device 112 and determines what to do with the data frames (e.g., store, send, etc.).

In FIG. 1, the audio/video output device 112 is a smart phone, a video camera, a television, a speaker, and/or any other type of device that produces audio and/or video data frames.

It should be noted that although most artificial intelligence models operate as a monolithic component (e.g., input→model→output), in this example the model 108 is dissected and intercepted such that only parts of the model 108 run at a time. For example, the first compute engine 104 does not automatically execute upon a completion of vector embedding. The optimization circuitry 102 facilitates the operation of the first compute engine 104 on the model 108. For the optimization circuitry 102 to facilitate, the optimization circuitry 102 requires access to the model 108. For example, the model 108 has to be an open source model or licensed to be used by the optimization circuitry 102.

FIG. 2 is a block diagram of an example implementation of the optimization circuitry 102 of FIG. 1 to do reduce an unnecessary use of the first compute engine 104 of FIG. 1. The optimization circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the optimization circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

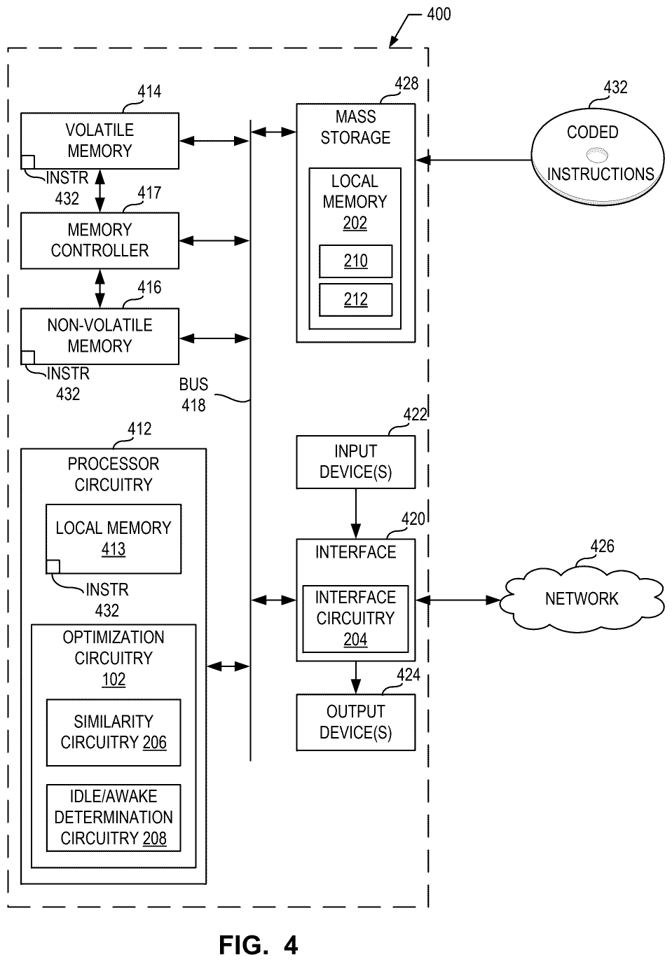

In FIG. 2, the optimization circuitry 102 includes an example local memory 202, example interface circuitry 204, example similarity circuitry 206, and example idle/awake determination circuitry 208. In some examples, the interface circuitry 204 is instantiated by programmable circuitry executing third interface circuitry instructions and/or configured to perform operations such as those represented by the flowchart(s) of FIG. 4. In some examples, the similarity circuitry 206 is instantiated by programmable circuitry executing similarity circuitry instructions and/or configured to perform operations such as those represented by the flowchart(s) of FIG. 4. In some examples, the idle/awake determination circuitry 208 is instantiated by programmable circuitry executing idle/awake determination circuitry instructions and/or configured to perform operations such as those represented by the flowchart(s) of FIG. 4.

In FIG. 2, the local memory 202 stores current embedded vector(s) 210 and prior classified vector(s) 212. In some examples, the local memory 202 is a cache located closer to the similarity circuitry 206 and idle/awake determination circuitry 208 and, thus, is quickly accessible. The local memory 202 of FIG. 2 is implemented by any memory, storage device and/or storage disc for storing data such as, for example, flash memory, magnetic media, optical media, solid state memory, hard drive(s), thumb drive(s), etc. Furthermore, the data stored in the example local memory 202 may be in any data format such as, for example, binary data, comma delimited data, tab delimited data, structured query language (SQL) structures, etc. While, in the illustrated example, the example local memory 202 is illustrated as a single memory, the local memory 202 and/or any other data storage devices described herein may be implemented by any number and/or type(s) of memories. The local memory 202 may implement the means for storing embedded vectors 210 and prior classified vectors 212.

In FIG. 2, the interface circuitry 204 controls instructions and requests between the optimization circuitry 102 and the first and second compute engines 104, 110 of FIG. 1. For example, the interface circuitry 204 requests the second compute engine 110 to send embedded vectors 210 output in substantially real time by the top layer 114 of the model 108 of FIG. 1. The interface circuitry 204 sends idle state instructions or awake state instructions to the first compute engine 104 of FIG. 1.

In FIG. 2, the similarity circuitry 206 measures a similarity between an embedded vector 210 and the prior classified vectors 212. In this example, the embedded vector 210 is a recent vector output by the second compute engine 110 executing the top layer 114. In this example, the prior classified vector(s) 212 are one or more vectors that were previously output by the second and/or first compute engines 110, 104. For example, a first prior classified vector may be a vector processed by the first compute engine 104 having a positive classification. For example, the first prior classified vector is classified as a particular speaker, a deepfake/cloned audio, audio with explicit content, or political speech. A second prior classified vector may be a vector processed by the second compute engine 110 that has a negative classification, such as broadband noise or real/non-deepfake audio. A prior classified vector 122 receives a negative classification when the model 108 does not detect what the model 108 is configured to detect, such as a speaker, cloned/deepfake audio, explicit speech, political speech, etc.

In some examples, to determine the similarity between an embedded vector 210 and the prior classified vectors 212, the similarity circuitry 206 selects prior classified vectors 212 that are adjacent neighbors to the embedded vector 210. Prior classified vectors 212 are considered adjacent neighbors to the embedded vector 210 when they have a timestamp within a certain threshold of the timestamp of the embedded vector 210. For example, an embedded vector with timestamp T may have adjacent neighbor vectors with timestamps T-1, T-2, T-3, etc., where “1”, “2”, “3” are seconds, milliseconds, nanoseconds, etc.

The similarity circuitry 206 then measures the similarity between the embedded vector and the selected prior classified vectors using any type of similarity algorithm. In some examples, the similarity circuitry 206 implements a cosine similarity algorithm where the similarity circuitry 206 measures the cosine of the angle between the two non-zero vectors A (the embedded vector 210) and B (one of the selected prior classified vectors) within a product space. The cosine similarity is a value bound by a constrained range of 0 and 1. Therefore, when an angle between the two vectors is closer to a value of 0, that means that the two vectors are orthogonal or perpendicular to each other and, thus, less similar. When the angle between the two vectors is closer to a value of 1, that means that the angle is smaller and the two vectors are more similar.

In some examples, the similarity circuitry 206 implements a locality sensitive hashing (LSH) algorithm where the similarity circuitry 206 hashes the embedded vector 210 and the selected prior classified vectors 212 and determines whether the hashed embedded vector 210 is similar to any of the hashed prior classified vectors.

Additionally and/or alternatively, the similarity circuitry 206 implements any type of similarity algorithm to determine the similarity between the embedded vector 210 and the selected prior classified vectors.

In some examples, the similarity circuitry 206 does not select adjacent neighbor vectors from the prior classified vectors 212 and instead measures the similarity between the embedded vector 210 and all the prior classified vectors 212 in the local memory 202. For example, the similarity circuitry 206 may look at distant neighbor vectors, as long as a threshold for similarity is set accordingly. The threshold for similarity may be set based on what type of similarity algorithm is implemented. For example, when cosine similarity is used by the similarity circuitry 206, the similarity threshold may be set to a value that outputs an accurate determination of similarity, such as 0.8, 0.9, etc. When the LSH algorithm is used by the similarity circuitry 206, the similarity threshold may be set to a value that outputs an accurate determination of similarity, such as hash values within the hundredths, thousandths, hundred thousandths, etc.

In some examples, the similarity circuitry 206 is configured to select adjacent neighbors or use all prior classified vectors 212 based on a user preference. Users may wish to select adjacent neighbors to determine similarity when the model task is time sensitive and classification changes frequently and/or there are a plurality of classification types. Users may wish to use all prior classified vectors 212 to determine similarity when the model task is time sensitive but the classification does not change as frequently and/or when then the classification only has only a few classification types.

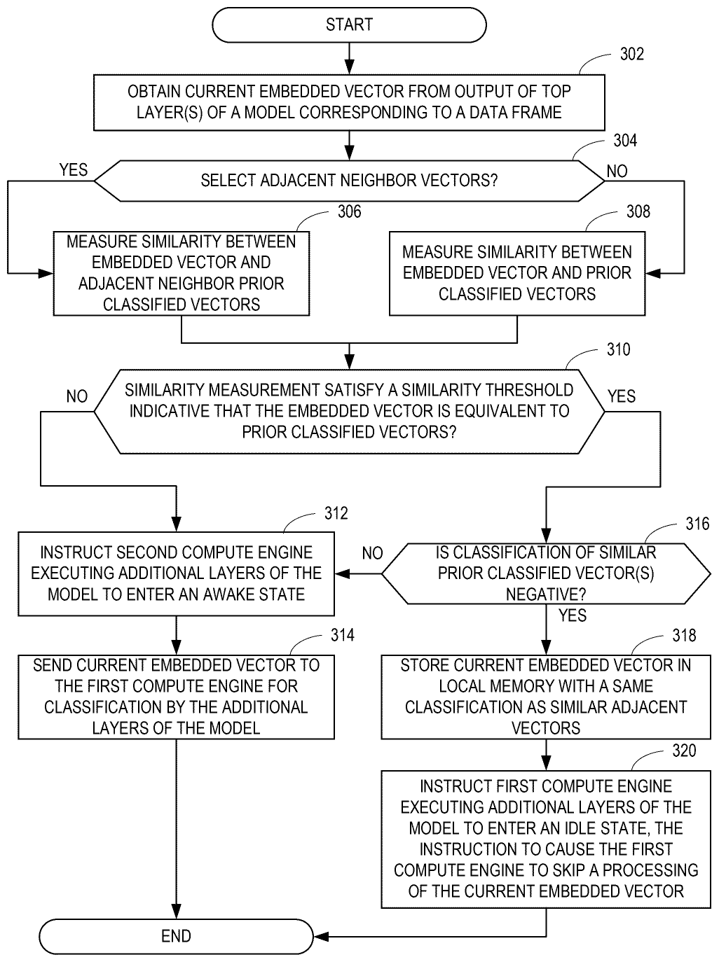

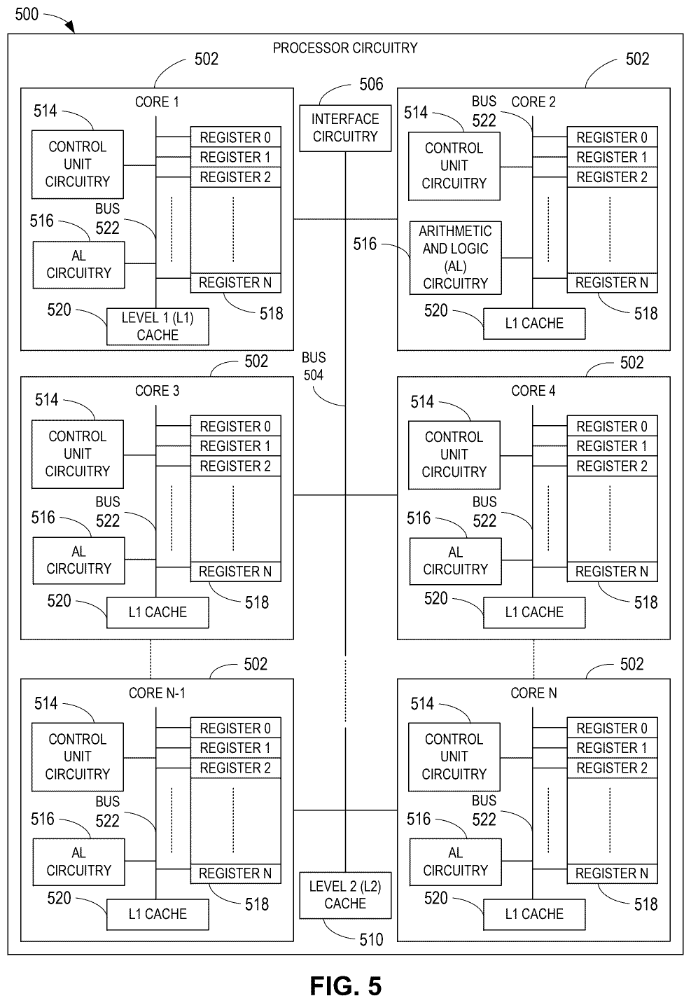

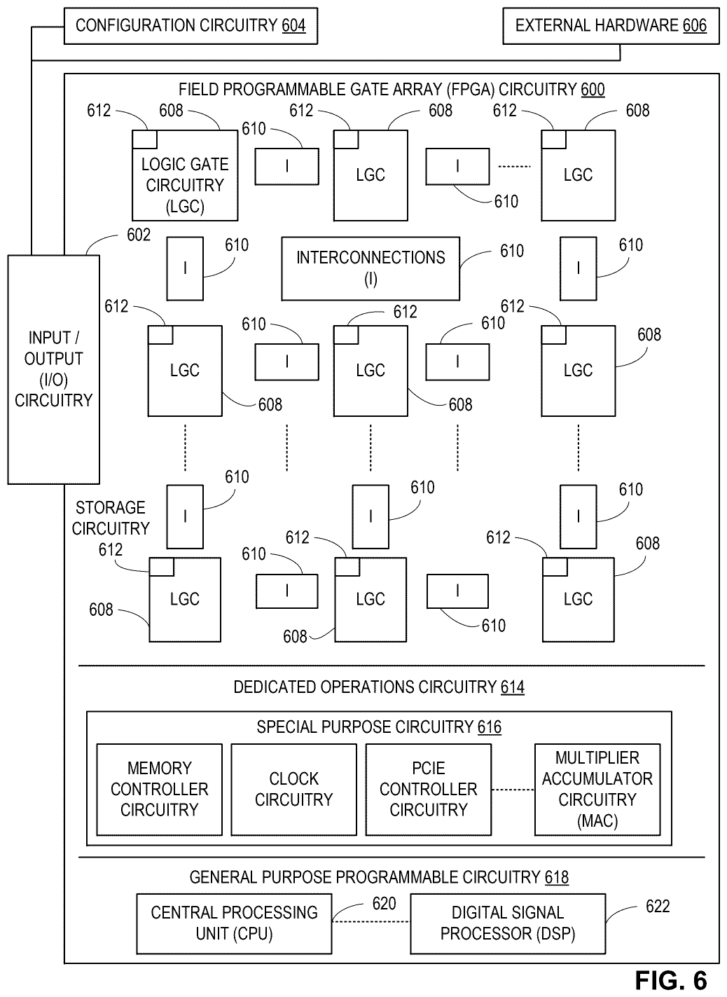

In some examples, the optimization circuitry 102 includes means for determining a similarity between a current embedded vector and prior classified vectors. For example, the means for determining a similarity between a current embedded vector and prior classified vectors may be implemented by similarity circuitry 206. In some examples, the similarity circuitry 206 may be instantiated by programmable circuitry such as the example programmable circuitry 412 of FIG. 4. For instance, the similarity circuitry 206 may be instantiated by the example microprocessor 500 of FIG. 5 executing machine executable instructions such as those implemented by at least blocks 304, 306, and 308 of FIG. 3. In some examples, the similarity circuitry 206 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the similarity circuitry 206 may be instantiated by any other combination of hardware, software, and/or firmware. For example, the similarity circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for determining a similarity between a current embedded vector and prior classified vectors includes means for selecting adjacent neighbor vectors.

In FIG. 2, the idle/awake determination circuitry 208 determines whether the first compute engine 104 should classify the embedded vector 210 based on its similarity to the prior classified vectors 212. The idle/awake determination circuitry 208 obtains the similarity measurement from the similarity circuitry 206 and compares the similarity measurements to the similarity threshold to determine whether the similarity measurement satisfies the similarity threshold. As used herein, “similarity threshold” and “threshold of similarity” are used interchangeably and define when an embedded vector 210 is sufficiently similar to a prior classified vector 212.

In some examples, when the idle/awake determination circuitry 208 determines that the similarity measurement satisfies the similarity threshold, the idle/awake determination circuitry 208 further determines whether the similar prior classified vector(s) 212 have a positive or a negative classification. For example, the idle/awake determination circuitry 208 determines whether the model 108 has detected a speaker based on the similar prior classified vector(s) 212 or whether the model 108 has detected broadband noise based on the similar prior classified vector(s) 212.

In some examples, if the idle/awake determination circuitry 208 determines that the similar prior classified vector 212 has a negative classification (e.g., is associated with broadband noise, silence, etc.), then the idle/awake determination circuitry 208 extrapolates that the current embedded vector 210 is the same classification as one or more of the prior classified vectors 212 and can be skipped. This means that the rest of the model layers (e.g., dense layers 106) can be skipped, as there is no need to run inference on the current embedded vector 210. In this example, the idle/awake determination circuitry 208 generates instructions that are to cause the first compute engine 104 to enter an idle state. For example, the instructions cause the first compute engine 104 to stop fetching data (e.g., weights and vectors) from memory. Additionally, the idle/awake determination circuitry 208 stores the current embedded vector 210 in the local memory 202 with the same negative classification as the similar prior classified vector(s) 212.

In some examples, if the idle/awake determination circuitry 208 determines that the similar prior classified vector 212 has a positive classification (e.g., is associated with a speaker), then the idle/awake determination circuitry 208 determines that inference is required to classify the current embedded vector 210. Inference is necessary for current vectors having similar features as positively classified vectors because the optimization circuitry 102 is to optimize for both accuracy and resource utilization. To optimize for accuracy, any data frame (transformed into an embedded vector) should be classified by the model 108 if the data frame is similar to a data frame that was classified as a speaker, deepfake, explicit speech, etc., in order to increase accuracy. For example, the chance of identifying a data frame where exactly the same (positive) data frame (e.g., cloned audio of the speaker saying “airplane”) is encountered again is improbable, unless the similarity threshold is so high that the purpose of optimizing for resource utilization is defeated. Therefore, it is desirable to scan this frame (e.g., cause the first compute engine 104 to execute the dense layers 106 on the frame) in case the neighborhood of previous frames may not have been accurate or reliable on the positive side of the analysis. Similar prior classified vector(s) 212 with negative classifications can be skipped and the first compute engine 104 can be put in an idle state because it is highly probable that the current embedded vector 210 is irrelevant (e.g., no one is speaking, there is a transition between speech and non-speech audio, etc.).

In some examples, when the idle/awake determination circuitry 208 determines the similarity measurement does not satisfy the similarity threshold (or that the similar prior classified vector(s) 212 has/have a positive classification), the idle/awake determination circuitry 208 determines that inference is required to classify the current embedded vector 210. This means that the dense layer 106 of the model 108 needs to be run on the current embedded vector 210. In such an example, the idle/awake determination circuitry 208 generates instructions that are to cause the first compute engine 104 to enter an awake state. For example, the instructions cause the first compute engine 104 to prepare for classification by fetching data (e.g., weights) from memory and by fetching the current embedded vector 210 from the second compute engine 110 and initiate computation engines and the like to identify what the current data frame (e.g., the current embedded vector) is.

In some examples, the optimization circuitry 102 includes means for instructing a compute engine to enter an idle state based on a similarity measurement. For example, the means for instructing a compute engine to enter an idle state based on a similarity measurement may be implemented by idle/awake determination circuitry 208. In some examples, the idle/awake determination circuitry 208 may be instantiated by programmable circuitry such as the example programmable circuitry 412 of FIG. 4. For instance, the idle/awake determination circuitry 208 may be instantiated by the example microprocessor 500 of FIG. 5 executing machine executable instructions such as those implemented by at least blocks 310, 312, 314, 316, 318, and 320 of FIG. 3. In some examples, the idle/awake determination circuitry 208 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the idle/awake determination circuitry 208 may be instantiated by any other combination of hardware, software, and/or firmware. For example, the idle/awake determination circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for instructing a compute engine to enter an idle state based on a similarity measurement includes means for comparing a similarity measurement to a similarity threshold to determine whether the similarity measurement satisfies the similarity threshold. In some examples, the means for instructing a compute engine to enter an idle state based on a similarity measurement includes means for instructing the compute engine to enter an awake state.

While an example manner of implementing the optimization circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the local memory 202, the example interface circuitry 204, the example similarity circuitry 206, the example idle/awake determination circuitry 208, and/or, more generally, the example optimization circuitry 102 of FIG. 2, may be implemented by hardware alone or by hardware in combination with software and/or firmware. Thus, for example, any of the local memory 202, the example interface circuitry 204, the example similarity circuitry 206, the example idle/awake determination circuitry 208, and/or, more generally, the example optimization circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example optimization circuitry 102 of FIG. 2 may include one or more elements, processes, and/or devices in addition to, or instead of, those illustrated in FIG. 2, and/or may include more than one of any or all of the illustrated elements, processes and devices.

A flowchart representative of example machine readable instructions, which may be executed by programmable circuitry to implement and/or instantiate the optimization circuitry 102 of FIG. 2 and/or representative of example operations which may be performed by programmable circuitry to implement and/or instantiate the optimization circuitry 102 of FIG. 2, is shown in FIG. 3. The machine readable instructions may be one or more executable programs or portion(s) of one or more executable programs for execution by programmable circuitry such as the programmable circuitry 412 shown in the example programmable circuitry platform 400 discussed below in connection with FIG. 4 and/or may be one or more function(s) or portion(s) of functions to be performed by the example programmable circuitry (e.g., an FPGA) discussed below in connection with FIGS. 5 and/or 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 3, many other methods of implementing the example optimization circuitry 102 may alternatively be used. For example, the order of execution of the blocks of the flowchart may be changed, and/or some of the blocks described may be changed, eliminated, or combined. Additionally or alternatively, any or all of the blocks of the flowchart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to implement the optimization circuitry 102 of FIGS. 1 and 2. The example machine-readable instructions and/or the example operations 300 of FIG. 3 begin at block 302, at which the optimization circuitry 102 obtains a current embedded vector 210 from the output of the top layer 114 (FIG. 1) of the model 108 (FIG. 1) corresponding to a data frame. For example, the interface circuitry 204 (FIG. 2) sends a request to the second compute engine 110 (FIG. 1) for output vectors as the top layer 114 completes embedding.

At block 304, the optimization circuitry 102 determines whether to select adjacent neighbor vectors. For example, the similarity circuitry 206 (FIG. 2) determines whether a user preference has been set to select adjacent neighbors for similarity measurement or whether a user preference has been set to use all prior classified vectors 212 for similarity measurement.

At block 304, when the optimization circuitry 102 determines that a user preference is to select adjacent neighbor vectors (e.g., block 304 returns a value YES), the optimization circuitry 102 measures a similarity between the embedded vector 210 and adjacent neighbor prior classified vectors (block 306). For example, the similarity circuitry 206 computes a similarity algorithm on the embedded vector 210 and adjacent neighbor prior classified vectors to identify a similarity value of the vector 210 to the adjacent neighbor prior classified vectors. In some examples, a similarity value is determined between the embedded vector 210 and every adjacent neighbor prior classified vector.

At block 304, when the optimization circuitry 102 determines that a user preference does not require a selection of adjacent neighbor vectors (e.g., block 304 returns a value NO), the optimization circuitry 102 measures a similarity between the embedded vector 210 and prior classified vectors 212 (block 308). For example, the similarity circuitry 206 computes a similarity algorithm on the embedded vector 210 and the prior classified vectors 212 to identify a similarity value of the vector 210 to the prior classified vectors 212.

At block 310, the optimization circuitry 102 determines whether the similarity measurement satisfies a similarity threshold indicative that the embedded vector 210 is equivalent to prior classified vectors 212. For example, the idle/awake determination circuitry 208 (FIG. 2) compares the similarity measurements to the similarity threshold, preconfigured by a user or by default. When the similarity circuitry 206 implements cosine similarity, the similarity threshold may be a value between 0.8 and 1. When the similarity circuitry 206 implements LSH, the similarity threshold may be a value in the hundredths, thousandths, hundred thousandths, etc. Additionally and/or alternatively, the similarity threshold may be any value sufficient to indicate that features of the embedded vector 210 are the same as or highly similar to features of any of the prior classified vectors 212.

At block 310, when the optimization circuitry 102 determines that the similarity measurement does not satisfy the similarity threshold (e.g., block 310 returns a value NO), the optimization circuitry 102 instructs the second compute engine 104 executing additional layers of the model 108 to enter an awake state (block 312). For example, the idle/awake determination circuitry 208 determines that inference is required and generates an instruction that is to cause the second compute engine 104 to fetch weights from memory and initialize internal computation engines to classify the embedded vector 210.

At block 314, the optimization circuitry 102 sends the current embedded vector 210 to the first compute engine 104 for classification by the additional layers of the model 108. For example, the idle/awake determination circuitry 208 instructs the first compute engine 104 to retrieve the current embedded vector 210 from the second compute engine 110 and initializes the dense layers 106 of the model 108. The operations 300 end until another embedded vector 210 is obtained, and then operations 300 are repeated.

Returning to block 310, when the optimization circuitry 102 determines that the similarity measurement satisfies the similarity threshold (e.g., block 310 returns a value YES), the optimization circuitry 102 determines whether a classification of similar prior classified vector(s) negative (block 316). For example, the idle/awake determination circuitry 208 determines whether the similar prior classified vector(s) 212 have been identified as a speaker or identified as broadband noise.

At block 316, if the optimization circuitry 102 determines that the classification of similar prior classified vector(s) is not negative (e.g., block 316 returns a value NO), control returns to block 312. For example, the idle/awake determination circuitry 208 determines that the classification of the prior vectors cannot be used to classify the current embedded vector 210, and inference needs to be performed on the current embedded vector 210.

At block 316, if the optimization circuitry 102 determines that the classification of similar prior classified vector(s) is negative (e.g., block 316 returns a value YES), the optimization circuitry 102 stores the current embedded vector in the local memory 202 with a same classification as the similar prior classified vector(s) (block 318). For example, the idle/awake determination circuitry 208 determines that inference does not need to be performed on the current embedded vector 210 based on the fact that the current embedded vector 210 has features highly similar to or equivalent to features of vectors that have been classified as broadband noise.

At block 320, the optimization circuitry 102 instructs the first compute engine 104 executing additional layers of the model 108 to enter an idle state, the instruction to cause the first compute engine 104 to skip a processing of the current embedded vector 210. For example, the idle/awake determination circuitry 208 generates an instruction that is to cause the first compute engine 104 to stop fetching data (e.g., weights and vectors) from memory.

The operations 300 end when the optimization circuitry 102 sends instructions to the first compute engine 104. The operations 300 repeat when another embedded vector 210 is obtained.

FIG. 4 is a block diagram of an example programmable circuitry platform 400 structured to execute and/or instantiate the example machine-readable instructions and/or the example operations of FIG. 3 to implement the optimization circuitry 102 of FIG. 2. The programmable circuitry platform 400 can be, for example, a server, a personal computer, a workstation, a self-learning machine (e.g., a neural network), a mobile device (e.g., a cell phone, a smart phone, a tablet such as an iPad™), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the example optimization circuitry 102, the example similarity circuitry 206, and the example idle/awake determination circuitry 208.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 420 implements the example interface circuitry 204 of FIG. 2.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a keyboard, a button, a mouse, a touchscreen, and/or an isopoint device.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), and/or a cathode ray tube (CRT) display. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the mass storage device 428 implements the example local memory 202 of FIG. 2 to store embedded vector(s) 210 and prior classified vector(s) 212.

The machine readable instructions 432, which may be implemented by the machine readable instructions of FIG. 3, may be stored in the mass storage device 428, in the volatile memory 414, in the non-volatile memory 416, and/or on at least one non-transitory computer readable storage medium such as a CD or DVD which may be removable.

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowcharts of FIG. 3 to effectively instantiate the circuitry of FIG. 2 as logic circuits to perform operations corresponding to those machine readable instructions. In some such examples, the circuitry of FIG. 2 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowcharts of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart(s) of FIG. 3 but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 3. As such, the FPGA circuitry 600 may be configured and/or structured to effectively instantiate some or all of the operations/functions corresponding to the machine readable instructions of the flowchart(s) of FIG. 3 as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIG. 3 faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIG. 3 and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 5. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart(s) of FIG. 3 to perform first operation(s)/function(s), the FPGA circuitry 600 of FIG. 6 may be configured and/or structured to perform second operation(s)/function(s) corresponding to a second portion of the machine readable instructions represented by the flowcharts of FIG. [Flowcharts], and/or an ASIC may be configured and/or structured to perform third operation(s)/function(s) corresponding to a third portion of the machine readable instructions represented by the flowcharts of FIG. 3.

It should be understood that some or all of the circuitry of FIG. 2 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the circuitry of FIG. 2 may be implemented within one or more virtual machines and/or containers executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIG. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

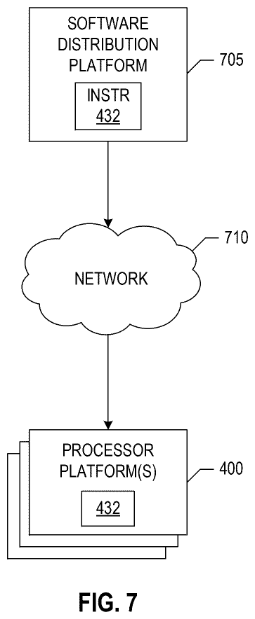

A block diagram illustrating an example software distribution platform 705 to distribute software such as the example machine readable instructions 432 of FIG. 4 to other hardware devices (e.g., hardware devices owned and/or operated by third parties from the owner and/or operator of the software distribution platform) is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions of FIG. 3, as described above. The one or more servers of the example software distribution platform 705 are in communication with an example network 710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions of FIG. [Flowcharts], may be downloaded to the example programmable circuitry platform 400, which is to execute the machine readable instructions 432 to implement the optimization circuitry 102. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that reduce resource utilization of inference workloads when such resource utilization would be redundant based on an prior inference workloads. For example, systems, methods, and apparatus disclosed herein intercept outputs of initial machine learning model layers, corresponding to a data frame, and determine a similarity of the outputs to previous outputs that have already been classified by the machine learning model. Resource utilization is redundant when current outputs are sufficiently similar to previous outputs, and, thus, example systems, methods, and apparatus disclosed herein cause compute engines to not use resources for sufficiently similar data frames. Disclosed systems, apparatus, articles of manufacture, and methods improve the efficiency of using a computing device by saving resources, used for inference workloads, for non-redundant. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to reduce a use of a compute engine executing dense layers in a model, the apparatus comprising:
interface circuitry;
machine readable instructions; and
programmable circuitry to at least one of instantiate or execute the machine readable instructions to:
obtain a first vector generated by an initial layer of the model, the first vector corresponding to a first data frame, wherein the initial layer of the model utilizes less computation resources than the dense layers are to utilize;
measure a similarity between the first vector and a prior vector, wherein the prior vector has been classified by the model and corresponds to a second data frame occurring before the first data frame represented by the first vector;
determine that the first vector satisfies a similarity threshold to the prior vector; and
instruct the compute engine to enter an idle state, the idle state to suspend execution of the dense layers in the model.

2. The apparatus of claim 1, wherein the first data frame is a frame of audio or video.

3. The apparatus of claim 1, wherein the programmable circuitry is to store the first vector in a cache with a same classification as the classification of the similar prior vector.

4. The apparatus of claim 1, wherein the compute engine is a first compute engine and the initial layer of the model is executed by a second compute engine different from the first compute engine.

5. The apparatus of claim 4, wherein the first compute engine is a graphics processing unit (GPU) or a neural processing unit (NPU) and the second compute engine is a central processing unit (CPU), wherein the first compute engine and the second compute engine operate to execute the model.

6. The apparatus of claim 4, wherein the initial layer of the model is to process the first data frame into the first vector that is representative of features of the first data frame that are to be analyzed by the second compute engine during classification of the first vector.

7. The apparatus of claim 1, wherein the programmable circuitry is to:
obtain a second vector generated by the initial layer of the model and corresponding to a third data frame;
measure a similarity between the second vector and prior vectors, the prior vectors including the first vector and the prior vector;
determine that the second vector does not satisfy the similarity threshold to the prior vectors; and
instruct a compute engine executing additional layers of the model to classify the second vector, wherein the instruction is to cause the compute engine to switch to an awake state to prepare for classification.

8. A non-transitory machine readable storage medium to reduce a use of a compute engine executing dense layers in a model comprising machine readable instructions to cause programmable circuitry to at least:
obtain a first vector generated by an initial layer of the model, the first vector corresponding to a first data frame, wherein the initial layer of the model utilizes less computation resources than the dense layers are to utilize;
measure a similarity between the first vector and a prior vector, wherein the prior vector has been classified by the model and corresponds to second data frames occurring before the first data frame represented by the first vector;
determine that the first vector satisfies a similarity threshold to the prior vector; and
instruct the compute engine to enter an idle state, the idle state to suspend execution of the dense layers in the model.

9. The at least one non-transitory machine readable storage medium of claim 8, wherein the first data frame is a frame of audio or video.

10. The at least one non-transitory machine readable storage medium of claim 8, wherein the machine readable instructions are to cause the programmable circuitry to is to store the first vector in a cache with a same classification as the classification of the similar prior vector.

11. The at least one non-transitory machine readable storage medium of claim 8, wherein the compute engine is a first compute engine and the initial layer of the model is executed by a second compute engine different from the first compute engine.

12. The at least one non-transitory machine readable storage medium of claim 11, wherein the first compute engine is a graphics processing unit (GPU) or a neural processing unit (NPU) and the second compute engine is a central processing unit (CPU), wherein the first compute engine and the second compute engine operate to execute the model.

13. The at least one non-transitory machine readable storage medium of claim 11, wherein the initial layer of the model is to process the first data frame into the first vector that is representative of features of the first data frame that are to be analyzed by the second compute engine during classification of the first vector.

14. The at least one non-transitory machine readable storage medium of claim 8, wherein the machine readable instructions are to cause the programmable circuitry to:
obtain a second vector generated by the initial layer of the model and corresponding to a third data frame;
measure a similarity between the second vector and prior vectors, the prior vectors including the first vector and the prior vector;
determine that the second vector does not satisfy the similarity threshold to the prior vectors; and
instruct a compute engine executing additional layers of the model to classify the second vector, wherein the instruction is to cause the compute engine to switch to an awake state to prepare for classification.

15. A server to distribute first software instructions on a network to reduce a use of a compute engine executing dense layers in a model, the server comprising:
at least one storage device including second instructions; and
at least one processor to execute the second instructions to transmit the first software instructions over the network, the first software instructions, when executed, to cause at least one device to:
obtain a first vector generated by an initial layer of the model, the first vector corresponding to a first data frame, wherein the initial layer of the model utilizes less computation resources than the dense layers are to utilize;
measure a similarity between the first vector and a prior vector, wherein the prior vector has been classified by the model and corresponds to second data frames occurring before the first data frame represented by the first vector;
determine that the first vector satisfies a similarity threshold to the prior vector; and
instruct the compute engine to enter an idle state, the idle state to suspend execution of the dense layers in the model.

16. The server of claim 15, wherein the first data frame is a frame of audio or video.

17. The server of claim 15, wherein the first software instructions are to cause the at least one device to store the first vector in a cache with a same classification as the classification of the similar prior vector.

18. The server of claim 15, wherein the compute engine is a first compute engine and the initial layer of the model is executed by a second compute engine different from the first compute engine.

19. The server of claim 18, wherein the first compute engine is a graphics processing unit (GPU) or a neural processing unit (NPU) and the second compute engine is a central processing unit (CPU), wherein the first compute engine and the second compute engine operate together to execute the model.

20. The server of claim 15, wherein the first software instructions are to cause the at least one device to
obtain a second vector generated by the initial layer of the model and corresponding to a third data frame;
measure a similarity between the second vector and prior vectors, the prior vectors including the first vector and the prior vector;
determine that the second vector does not satisfy the similarity threshold to the prior vectors; and
instruct a compute engine executing additional layers of the model to classify the second vector, wherein the instruction is to cause the compute engine to switch to an awake state to prepare for classification.
